(19) United States
(12) Patent Application Publication
(10) Pub. No.: US 2019/0292750 A1
(43) Pub. Date: Sep. 26, 2019

(54) METHOD FOR POSITIVE DRIVE OF ENDLESS TRACK FOR COMPACT TRACK LOADER AND CONSTRUCTION EQUIPMENT

(71) Applicant: ContiTech Transportbandsysteme GmbH, Hannover (DE)

(72) Inventor: Randall Franck, Berne, IN (US)

(73) Assignee: ContiTech Transportbandsysteme GmbH, Hannover (DE)

(21) Appl. No.: 15/933,403

(22) Filed: Mar. 23, 2018

(51) Int. Cl. E02F 9/02; E02F 3/34; B62D 55/06; B62D 55/24; B62D 55/125; B62D 55/14; B62D 11/00; B62D 55/10; E02F 9/22

(52) U.S. Cl. CPC E02F 9/02; E02F 3/3414; B62D 55/06; B62D 55/244; E02F 9/22; B62D 55/14; B62D 11/00; B62D 55/10; B62D 55/125

(57) ABSTRACT

Compact track loaders include a main body having a pair of drive shafts extending from opposing sides of the main body and an engine which drives the pair of drive shafts, and two track suspension systems, where each of the two track suspension systems is securely attached to each drive shaft of the pair of drive shafts, and the suspension system includes a positive drive wheel, a chassis, a front idler, a rear idler, and a plurality of rollers. An endless track is securely and movingly mounted onto each of the track suspension systems, and the endless track includes an elongate carcass, an outer portion having a plurality of ground engaging tread lugs, and an inner portion having a plurality of elastomeric guide-drive lugs. Only the two track suspension systems propel and steer the compact track loader, and vibration level is decreased up to 3 dB, 5 dB, or even 7 dB.

### FIELD

The field to which the disclosure generally relates to is compact track loaders, and more particularly to tracks and track suspension assemblies for compact track loaders.

### BACKGROUND

This section provides background information to facilitate a better understanding of the various aspects of the disclosure. It should be understood that the statements in this section of this document are to be read in this light, and not as admissions of prior art.

Compact track loaders have been in use for years, and conventional compact track loaders have two tracks (one on each side), each mounted on track suspension assembly, and the pair utilize “skid steering” to turn, move forward and move rearward. Use of the tracks allows the compact track loaders to have improved floatation and traction on various surface conditions. The conventional tracks are positive drive driven endless tracks, mounted on a track suspension assembly which is solidly mounted on the undercarriage of the compact track loaders. These positive drive systems have become the standard, and the tracks have metal guide-drive lugs embedded in the endless track, which are engaged with metal drive wheels to propel and turn the compact track loader.

Unfortunately, using tracks having metal guide-drive lugs engaged with metal drive wheels can result in a relatively rough ride for the operator of the compact track loader, as well as significant noise generation. This also gives rise to other issues such as durability failures of drive wheel and track due to steel on steel interface, durability failure of tracks due to high stress areas from the embedded steel components, as well as operator fatigue due increased vibration noise from the steel drives engaging the steel guide-drive lugs.

Thus, there is a need for improved endless track designs which address the above described problems, such need met at least in part with embodiments according to this disclosure.

### SUMMARY

This section provides a general summary of the disclosure, and is not necessarily a comprehensive disclosure of its full scope or all of its features.

In some aspects of the disclosure, a compact track loaders are provided which include a main body having a pair of drive shafts extending from opposing sides of the main body, and a track suspension system securely attached to each drive shaft of the pair of drive shafts, where the suspension system comprises a positive drive wheel, a chassis, a front idler, a rear idler, and a plurality of rollers. An endless track is securely and movingly mounted onto the track suspension system. The endless track includes an elongate carcass, an outer portion having a plurality of ground engaging tread lugs, and an inner portion having a plurality of guide-drive lugs. The plurality of guide-drive lugs are formed of an elastomeric material. The main body may include an engine which drives the pair of drive shafts, and the compact track loader may have only two track suspension systems, in some cases.

In some cases, each drive shaft of the pair of drive shafts drives the positive drive wheel of each of two track suspension systems, and the sound level is decreased by up to 3 dB(A) in comparison to OE track suspension systems, while in operation. The sound level may further be decreased up to 5 dB(A) in comparison to the OE track suspension system. In some cases vibration level is decreased up to 3 dB in comparison to OE track suspension systems while in operation, or even up to 5 dB, or 7 dB in comparison to the OE track suspension systems.

The compact track loaders may be propelled and steered by two track suspension systems. The two track suspension systems may remain orientated parallel with one another, and may remain parallel with sides of the main body while steering the compact track loader.

In other aspects of the disclosure, compact track loaders include a main body having a pair of drive shafts extending from opposing sides of the main body and an engine which drives the pair of drive shafts via a transmission (such as a hydrostatic transmission). The compact track loaders further include two track suspension systems, where each of the two track suspension systems is securely attached to each drive shaft of the pair of drive shafts, and the suspension system includes a positive drive wheel, a chassis, a front idler, a rear idler, and a plurality of rollers. An endless track is securely and movingly mounted onto each of the track suspension systems, and the endless track includes an elongate carcass, an outer portion having a plurality of ground engaging tread lugs, and an inner portion having a plurality of guide-drive lugs. The plurality of guide-drive lugs are formed of an elastomeric material. Only the two track suspension systems propel and steer the compact track loader, and vibration level is decreased up to 3 dB, decreased up to 5 dB, or even decreased up to 7 dB, in comparison to OE track suspension systems with metal guide-drive lugs, while in operation. In some cases, sound level may be decreased by up to 3 dB(A), or even decreased by up to 5 dB(A), in comparison to OE track suspension systems, while in operation.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 is a side perspective view of a compact track loader, in accordance with the disclosure;

FIG. 2 is a perspective view of a track suspension assembly, in accordance with the disclosure;

FIGS. 3A-3D depict a drive wheel, a roller wheel, an idler wheel, and an endless track in accordance with the disclosure; and,

FIGS. 4A-4F and Table 1 set forth the comparative testing data collected for an embodiment according to the disclosure in comparison with currently available state of the art equipment.

### DETAILED DESCRIPTION

The following description of the variations is merely illustrative in nature and is in no way intended to limit the scope of the disclosure, its application, or uses. The description is presented herein solely for the purpose of illustrating the various embodiments of the disclosure and should not be construed as a limitation to the scope and applicability of the disclosure. In the summary of the disclosure and this detailed description, each numerical value should be read once as modified by the term “about” (unless already expressly so modified), and then read again as not so modified unless otherwise indicated in context. Also, in the summary of the disclosure and this detailed description, it should be understood that a value range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors had possession of the entire range and all points within the range.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Also, as used herein any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

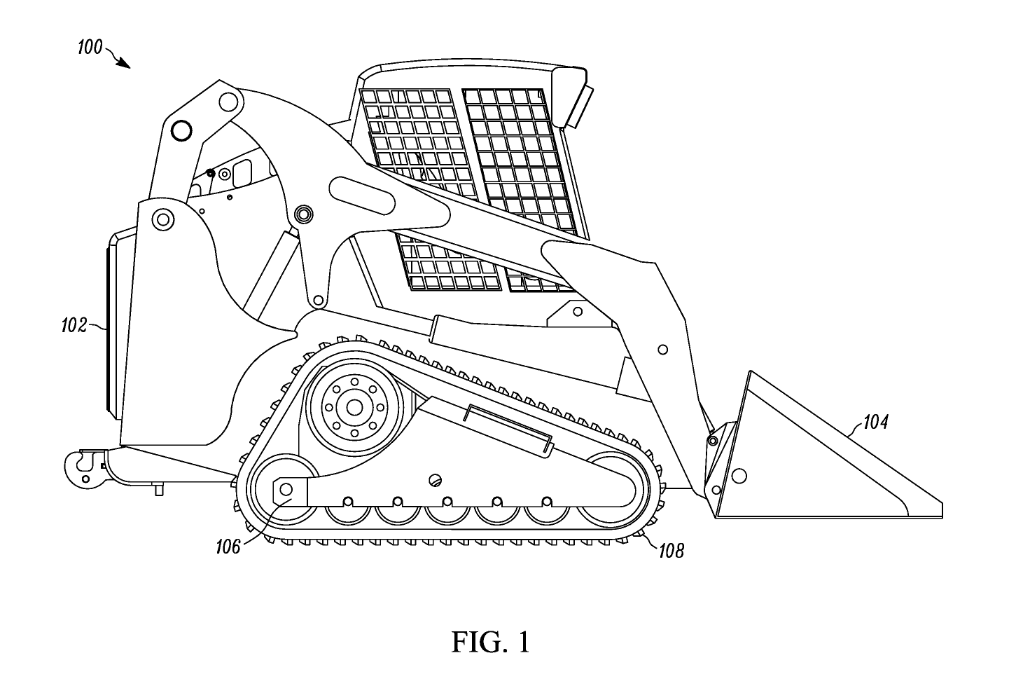

Now referencing FIG. 1 which illustrates a compact track loader 100 having a main body 102, an implement (bucket shown) 104 attached to the main body, two track suspension systems (one shown) 106 securely attached to the compact track loader main body 102, and an endless track 108 securely mounted upon each track suspension system (one shown) 106. Compact track loader 100 may be of any design known in the art, such as, but not necessary limited to those compact track loaders described in U.S. Pat. Nos. 7,156,200 and 6,869,153, the disclosures incorporated herein by reference thereto. In accordance with embodiments of this disclosure, endless tracks 108 include guide-drive lugs which have an elastomeric surface which engages the positive drive wheels of the track suspension systems 106, and such design and approach provides improvement over the problems associated with conventional systems. Such improvements provided by embodiments of the disclosure include improved durability of the positive drive wheel, improved durability of the endless track, reduced noise levels that operator must function within, reduced vibration levels the operator is exposed to, and/or the operator may work longer due to improved working conditions.

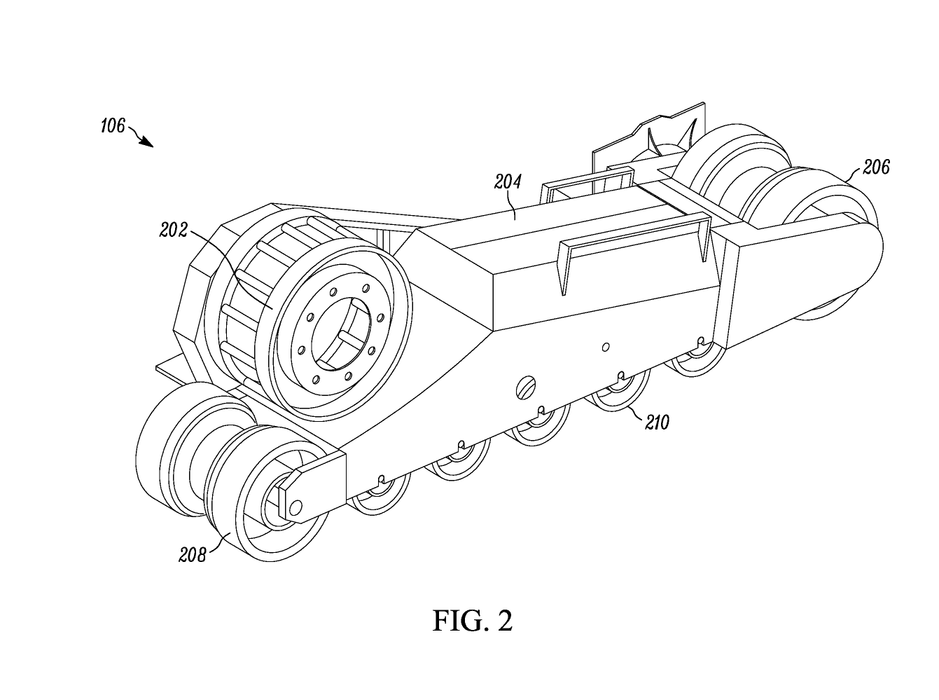

With reference to FIG. 2, track suspension system 106 is shown in greater detail, and generally includes positive drive wheel 202, chassis 204, front and rear idlers 206, 208, and rollers 210 (five shown). Track suspension systems 106 are attached to compact track loader 100 main body 102 by any suitable technique known to those with skill in the art. Furthermore, the pair of track suspension systems 106 with endless track 108 mounted thereon do not turn independent from main body 102. But rather, to turn compact track loader 100, either one positive drive wheel 202 is stopped or slowed relative the opposing side positive drive wheel 202,—or—one positive drive wheel 202 is reversed relative the opposing side positive drive wheel 202. This is distinguished from other vehicles which use three or four endless tracks, each mounted to a track suspension system, where one or two tracks do turn independently from the main body of the vehicle.

Referencing FIG. 2 again, each positive drive wheel 202 may be attached to a drive shaft extending from main body 102 of the compact track loader 100, a front idler 206 movably attached to a front portion of the chassis 204, and a rear idlers 208 movably attached to a rear portion of the chassis 204. A plurality of rollers 210 are movably attached to the chassis 204, and an endless track can be movably extending about the positive drive wheel, rollers and idlers. While the discussion of the present illustration involves a single track suspension system 106, it can be appreciated that the embodiments are intended for use as a pair of track suspension systems 106 operated on opposing sides of the compact track loader 100.

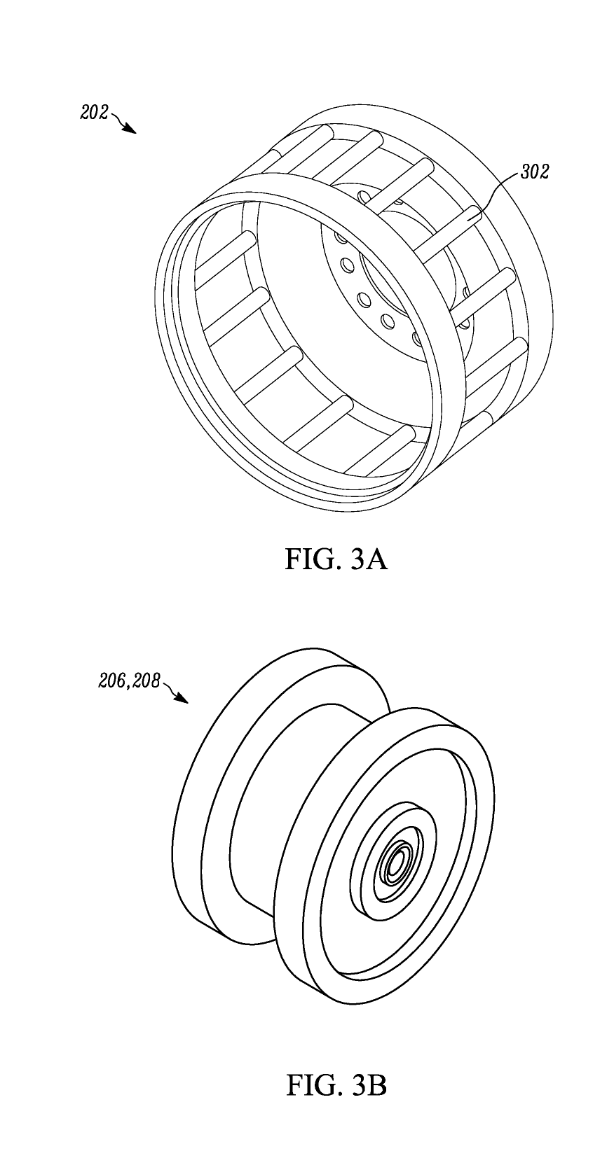

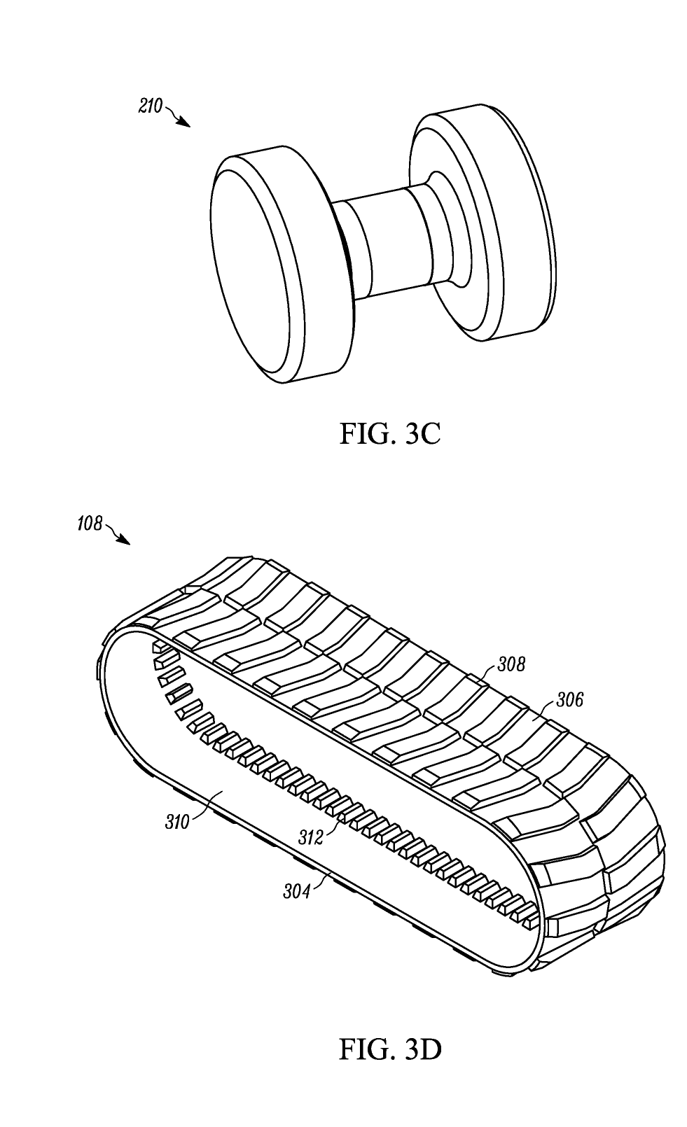

FIGS. 3A-3D illustrate some of the individual components useful in track suspension systems 106, and endless tracks 108 useful in some embodiments of the disclosure. FIG. 3A illustrates positive drive wheel 202, having a plurality of teeth or drive bars 302 that are positioned for mating engagement with elastomeric guide-drive lugs of the endless track 108. Positive drive wheel 202 is generally made of metal, and may be either forged or cast in manufacture. FIG. 3B depicts one design of front and rear idlers, 206, 208, useful in some embodiments although any suitable design is within the scope of the disclosure. FIG. 3C depicts one design of a roller 210 useful in some embodiments, although any suitable design is within the scope of the disclosure, as well.

FIG. 3D illustrates an endless track 108 which is securely and movingly mounted on track suspension system 106. The endless track 108 has an endless elongate carcass 304, an outer portion 306 having a plurality of ground engaging tread lugs 308, and an inner portion 310 having a plurality of guide-drive lugs 312. The guide-drive lugs 312 are formed in the endless track 108.

The endless elongate carcass 304, an outer portion 306 having a plurality of ground engaging tread lugs 308, and an inner portion 310 having a plurality of guide-drive lugs 312, are generally made of an elastomeric material. The elastomeric material forming these elements of endless track 108 may be any suitable material readily know to those of skill in the art, for example, but not limited to, natural rubber or synthetic rubber, such as emulsion styrene-butadiene rubber, solution styrene-butadiene rubber, synthetic polyisoprene rubber, polybutadiene rubber, or a blend of natural and synthetic rubbers, and the like. Also, the track carcass 304 typically includes one or more layers of natural rubber, synthetic rubber, elastomeric material, or any other suitable material know to those of skill in the art. Other non-elastomeric materials may be included in the endless track as well.

In some aspects, the endless track carcass 304 may include one or more layers of elastomeric material, and embedded within the carcass 304 are one or more reinforcement layers which extend transversely along the track width. The reinforcement layers may comprise longitudinal cable reinforcement layers, fabric reinforcement layers, or any other reinforcement layer known to those skilled in the art.

Ground engaging tread lugs 308 and guide-drive lugs 312 may also include reinforcements therein. Such reinforcements may be made up of a strength reinforcing material such as formed plate, a foil, a matrix of cords, rods, fibers, twisted fibers, or wires, or even a fabric sheet. In some aspects, useful high-modulus strength reinforcing materials include fibers, cords or fabric produced from aramid, fiberglass, nylon, polyester, cotton, steel, carbon fiber, acrylic, polyketone, hemp, jute, carbon fiber and polybenzoxazolepolyethylene naphthalate (PEN), segmented polyurethane, poly(p-phenylene-2,6-benzobisoxazole) (PBO), basalt, boron, or liquid crystal polymer (LCP).

To illustrate noise and vibration reduction, thus improvement over the current art, comparative noise and vibration data was collected for currently available equipment, and an embodiment according to the disclosure. A compact track loader (a Bobcat® T770) was acquired for collecting noise and vibration data. Baseline (original equipment, or as received, with metal guide-drive lugs) data for vibration was collected using triaxial accelerometers placed at the base of the operator seat mounting plate, the bracket connecting the operator hand rail to the loader structure, and on the main frame of the loader next to the hydraulic drive unit. The triaxial accelerometers were procured from PCB®, of Depew, N.Y. The triaxial accelerometers were calibrated from 5 Hz to 3 kHz for the vibration measurements.

Noise measurement data was recorded using a prepolarized free-field ½″ microphone calibrated from 1 to 20 kHz, which was procured from Bruel & Kjaer, Canton, Mich. Data was collected and analyzed using “Sonoscout” software and a 12 channel data acquisition LAX-XI 25.6 kHz hardware, all commercially available hardware and software are from Bruel & Kjaer.

Once the vibration and noise data was collected for the as received compact track loader, the compact track loader was then modified for fitting a positive drive endless track with elastomeric guide-drive lugs, according to the disclosure. The drive wheel, front and rear idler were replaced. The existing roller wheels were modified to securely accommodate the elastomeric guide-drive lugs of the positive drive endless track. The endless track was then installed, the noise and vibration data collected and analyzed. Then the data was compared to the data collect from the original equipment system.

Noise and vibration data was collected from the original “as received” (“OE”) compact track loader and again after modifications were made to the idlers, drive wheel, and rollers, and the elastomeric guide-drive lug endless track installed, as described above (track suspension system and endless track according to the disclosure, “TEST”). The compact track loader was driven across smooth concrete in an isolated location. The same area of road was used for both the OE and the TEST data collection. In both instances the vehicle was allowed to warm up, and several practice passes were made before collecting data.

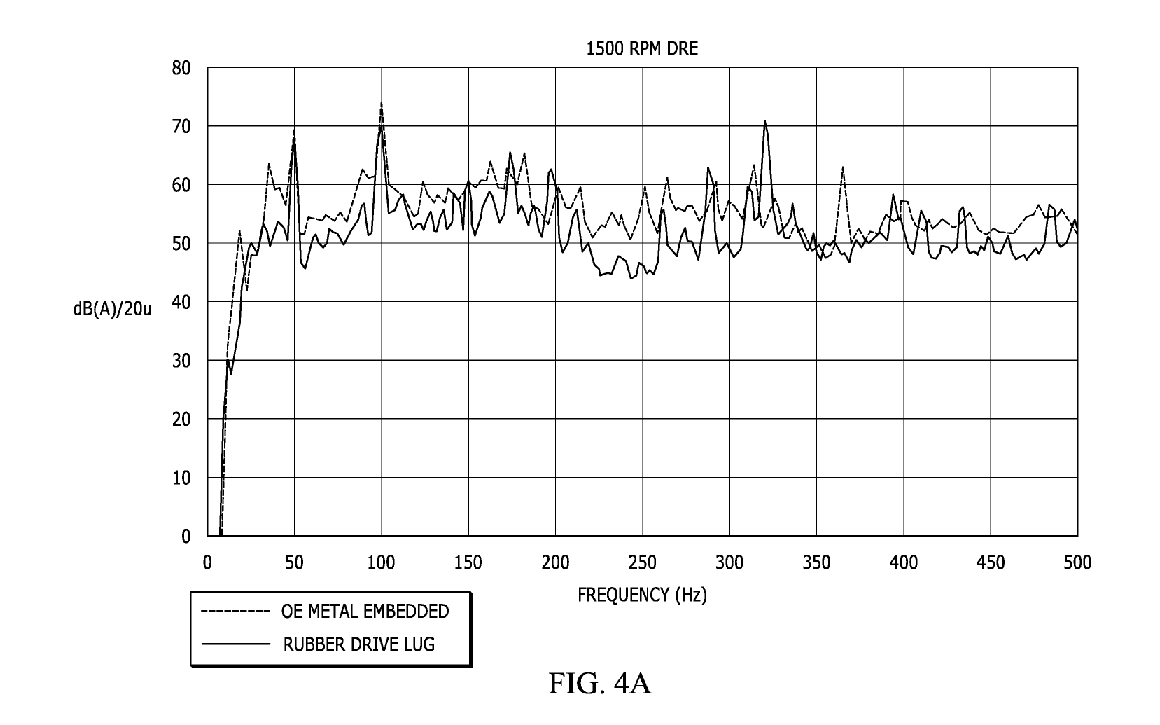

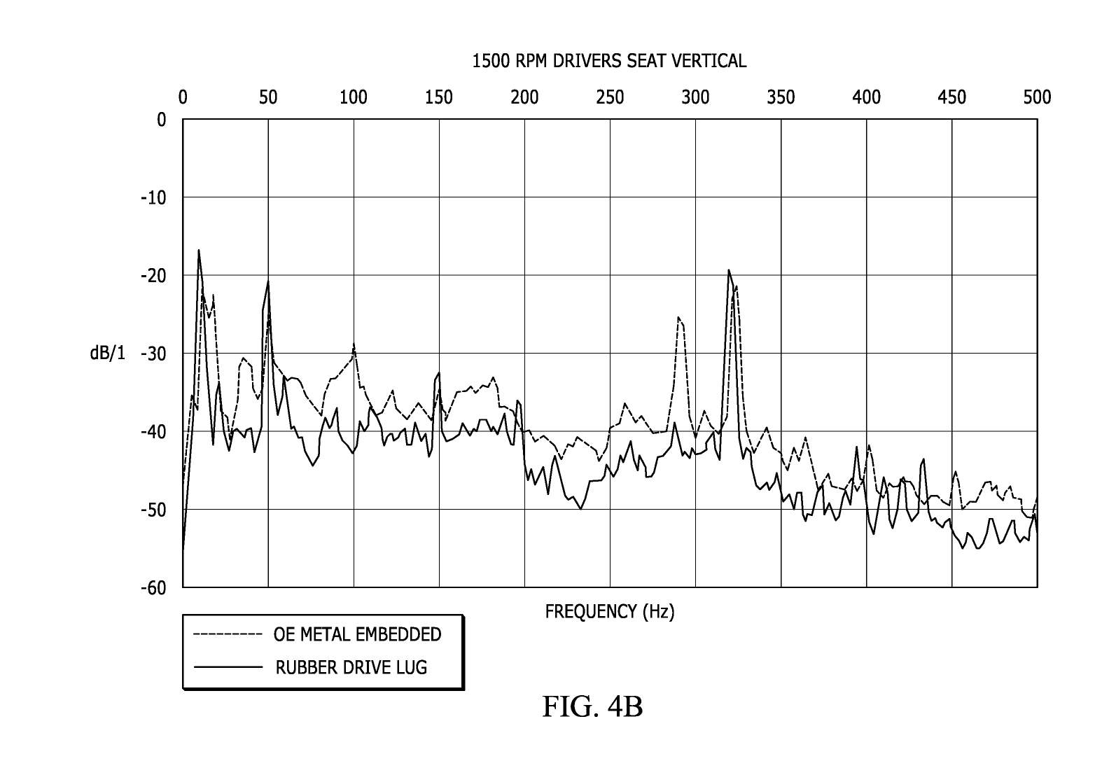

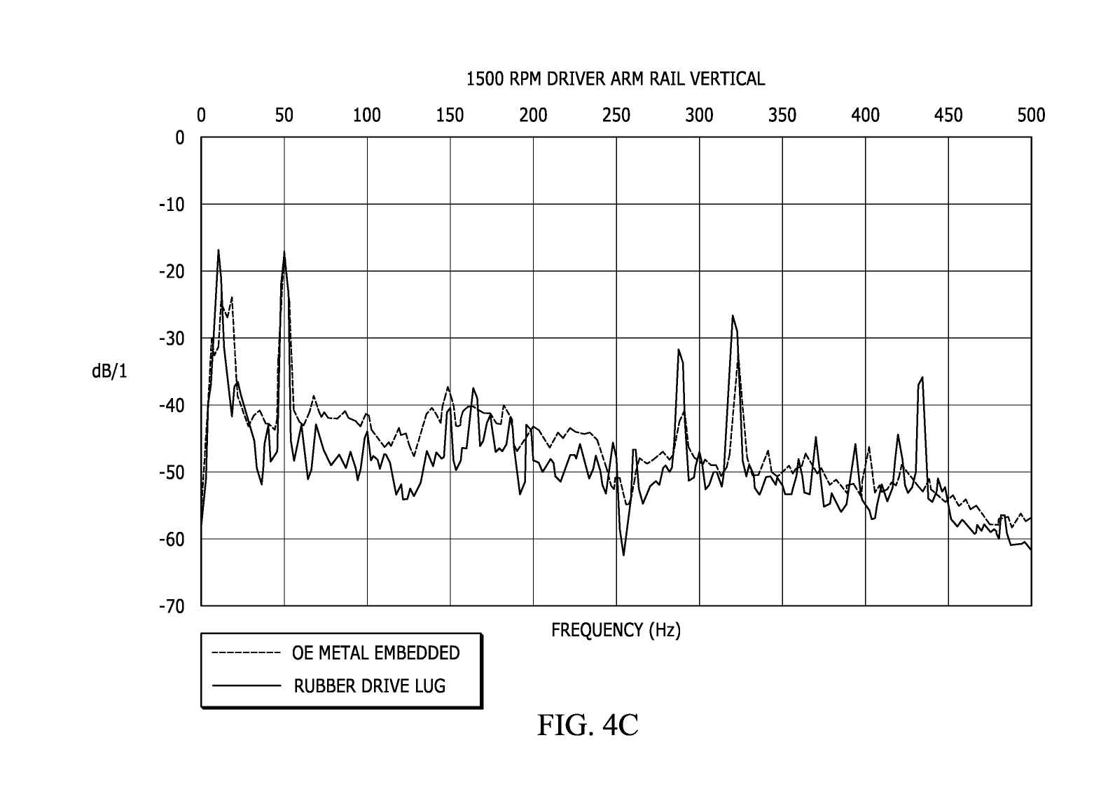

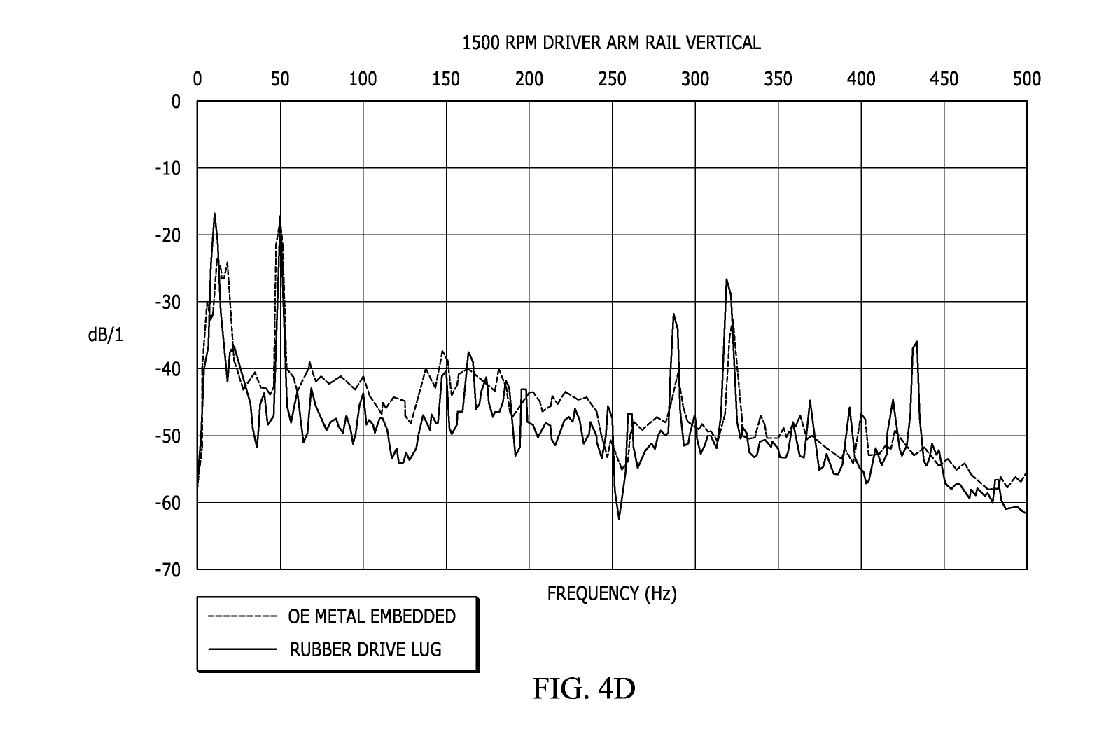

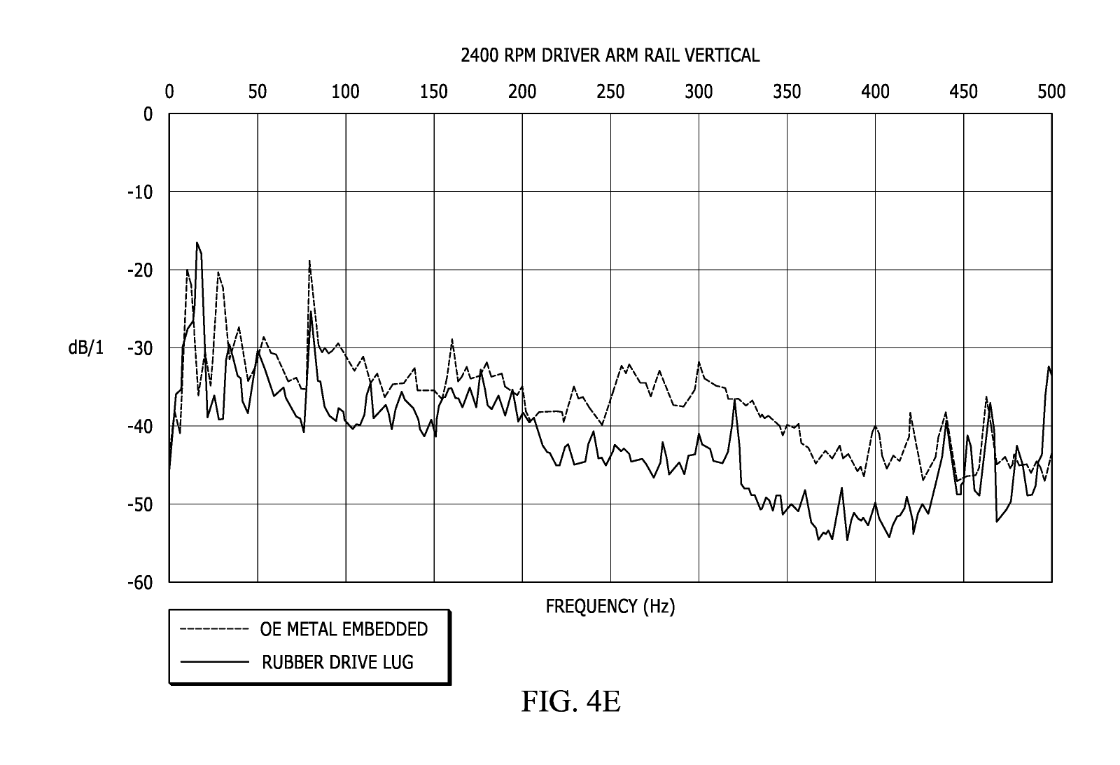

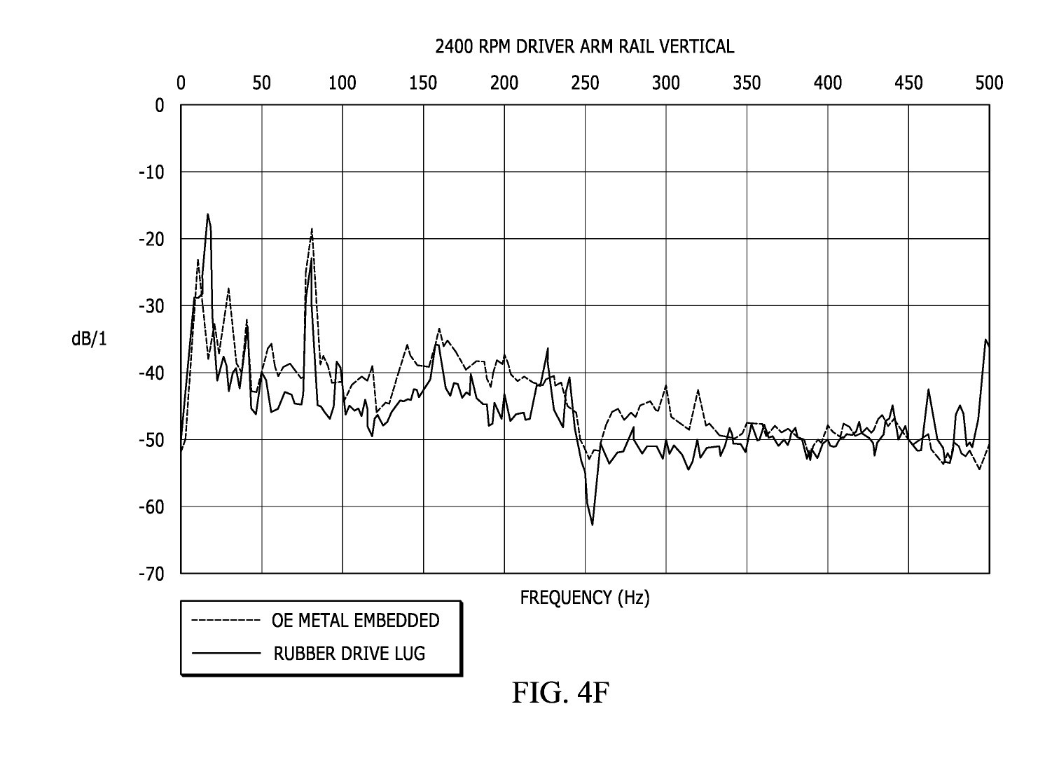

FIG. 4A-4F and Table 1 set forth the comparative data collected and a comparative summary, respectively. For each graph provided, data was collected several times and an average of those is provided for comparison. For the OE and the TEST, data was collected at two different engine speeds, which directly correlates to vehicle speed. The vibration is shown in dB, which is a logarithmic scale for the acceleration, while the noise is shown as dB using A weighting which is shown as dB(A). Since the focus of this evaluation was operator comfort the data is shown from 0 to 500 Hz. The vertical direction is provided as this was of particular interest for whole-body longitudinal vibration, but equal improvements for found in the lateral directions as well.

In regards to the data provided, each chart in FIG. 4A-4F includes one number for dB and dB(A) which is an estimate of the overall improvement the modified TEST system with elastomeric guide-drive lugs provides over the OE vehicle. So each relative point at the same frequency signifies less noise, or vibration. Less noise and, or vibration leads to a more comfortable condition for the operator. At nearly every frequency in the range shown, the elastomeric guide-drive lug system provides lower vibration levels at the operator seat, and hand rail. The microphone data also showed lower noise levels. This would allow an operator to use the compact track loader for longer periods of time and at greater comfort. In accordance with the disclosure, the improvement in sound levels was a decrease of up to 3 dB(A), a decrease of up to 5 dB(A), or even a decrease of up to from 3 dB(A) to 5 dB(A); and, improvement in vibration levels was a decrease of up to 3 dB, a decrease of up to 5 dB, a decrease of up to 7 dB, or even a decrease of up to from 3 dB to 7 dB. Such improvements are based upon comparison of the OE arrangement versus the TEST arrangement.

TABLE 1

| Noise | | | Vibration | | |
|---|---|---|---|---|---|
| Surface: | Smooth Road | | Surface: | Smooth Road | |
| Engine | 1500 | 2400 | Engine RPM: | 1500 | 2400 |
| RPM: | | | | | |
| DRE | −5 dB(A) | −3 dB(A) | Seat Z | −5 dB | −5 dB |
| | | | Arm Z | −5 dB | −3 dB |
| | | | Frame Z | −7 dB | −7 dB |

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Also, in some example embodiments, well-known processes, well-known device structures, and well-known technologies are not described in detail. Further, it will be readily apparent to those of skill in the art that in the design, manufacture, and operation of apparatus to achieve that described in the disclosure, variations in apparatus design, construction, condition, erosion of components, and gaps between components may present, for example.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

### LIST OF REFERENCE NUMERALS

100 Compact track loader
102 Compact track loader main body
104 Implement
106 Track suspension system
108 Endless track
202 Positive drive wheel
204 Chassis
206 Front Idler
208 Rear Idler
210 Roller
302 Positive drive wheel drive bars
304 Endless elongate track carcass
306 Track outer portion
308 Ground engaging tread lugs
310 Track inner portion
312 Elastomeric guide-drive lugs

What is claimed is:

1. A compact track loader comprising:
a. a main body comprising a pair of drive shafts extending from opposing sides of the main body;
b. a track suspension system securely attached to each drive shaft of the pair of drive shafts, wherein the suspension system comprises a positive drive wheel, a chassis, a front idler, a rear idler, and a plurality of rollers; and,
c. an endless track securely and movingly mounted onto the track suspension system, wherein the endless track comprises an elongate carcass, an outer portion having a plurality of ground engaging tread lugs, and an inner portion having a plurality of guide-drive lugs, and wherein the plurality of guide-drive lugs are formed of an elastomeric material.

2. The compact track loader according to claim 1, wherein the main body comprises an engine which drives the pair of drive shafts, and wherein the compact track loader has two track suspension systems.

3. The compact track loader according to claim 2, wherein each drive shaft of the pair of drive shafts drives the positive drive wheel of each of the two track suspension systems, and wherein sound level is decreased up to 3 dB(A) in comparison to OE track suspension systems while in operation.

4. The compact track loader according to claim 3, wherein the sound level is decreased up to 5 dB(A) in comparison to the OE track suspension system.

5. The compact track loader according to claim 2, wherein each drive shaft of the pair of drive shafts drives the positive drive wheel of each of the two track suspension systems, and wherein vibration level is decreased up to 3 dB in comparison to OE track suspension systems while in operation.

6. The compact track loader according to claim 5, wherein the vibration level is decreased up to 5 dB in comparison to the OE track suspension systems.

7. The compact track loader according to claim 6, wherein the vibration level is decreased up to 7 dB in comparison to the OE track suspension systems.

8. The compact track loader according to claim 5, wherein the vibration level is decreased from 3 dB to 7 dB in comparison to the OE track suspension systems.

9. The compact track loader according to claim 2, wherein the two track suspension systems propel and steer the compact track loader.

10. The compact track loader according to claim 9, wherein the two track suspension systems remain orientated parallel with one another and remain parallel sides of the main body while steering the compact track loader.

11. A compact track loader comprising:
a. a main body comprising a pair of drive shafts extending from opposing sides of the main body and an engine which drives the pair of drive shafts through a hydrostatic transmission;
b. two track suspension systems, each of the two track suspension systems securely attached to each drive shaft of the pair of drive shafts, and wherein the suspension system comprises a positive drive wheel, a chassis, a front idler, a rear idler, and a plurality of rollers; and,
c. an endless track securely and movingly mounted onto each of the two track suspension systems, wherein the endless track comprises an elongate carcass, an outer portion having a plurality of ground engaging tread lugs, and an inner portion having a plurality of guide-drive lugs, and wherein the plurality of guide-drive lugs are formed of an elastomeric material.
wherein only the two track suspension systems propel and steer the compact track loader, and wherein vibration level is decreased up to 3 dB in comparison to OE track suspension systems while in operation.

12. The compact track loader according to claim 11, wherein sound level is decreased up to 3 dB(A) in comparison to OE track suspension systems while in operation.

13. The compact track loader according to claim 12, wherein the sound level is decreased up to 5 dB(A) in comparison to the OE track suspension system.

14. The compact track loader according to claim 11, wherein the vibration level is decreased up to 5 dB in comparison to the OE track suspension systems.

15. The compact track loader according to claim 14, wherein the vibration level is decreased up to 7 dB in comparison to the OE track suspension systems.

16. The compact track loader according to claim 11, wherein the vibration level is decreased from 3 dB to 7 dB in comparison to the OE track suspension systems.

17. The compact track loader according to claim 11, wherein the two track suspension systems propel and steer the compact track loader.

18. The compact track loader according to claim 17, wherein the two track suspension systems remain orientated parallel with one another and remain parallel sides of the main body while steering the compact track loader.

19. A compact track loader comprising:
a. a main body comprising a pair of drive shafts extending from opposing sides of the main body and an engine which drives the pair of drive shafts through a hydrostatic transmission;
b. two track suspension systems, each of the two track suspension systems securely attached to each drive shaft of the pair of drive shafts, and wherein the suspension system comprises a positive drive wheel, a chassis, a front idler, a rear idler, and a plurality of rollers; and,
c. an endless track securely and movingly mounted onto each of the two track suspension systems, wherein the endless track comprises an elongate carcass, an outer portion having a plurality of ground engaging tread lugs, and an inner portion having a plurality of guide-drive lugs, and wherein the plurality of guide-drive lugs are formed of an elastomeric material.
wherein only the two track suspension systems propel and steer the compact track loader, and wherein sound level is decreased up to 3 dB(A) in comparison to OE track suspension systems while in operation.

20. The compact track loader according to claim 19, wherein the sound level is decreased up to 5 dB(A) in comparison to the OE track suspension system.
